(19) United States
(12) Patent Application Publication
(10) Pub. No.: US 2018/0002463 A1
(43) Pub. Date: Jan. 4, 2018

(54) COATING COMPOSITION AND COATING FILM PREPARAED THEREFROM

(71) Applicant: LG CHEM, LTD., Seoul (KR)

(72) Inventors: Han Na LEE, Daejeon (KR); Young Suk KIM, Daejeon (KR); Yeong Rae CHANG, Daejeon (KR)

(21) Appl. No.: 15/543,530

(22) PCT Filed: Feb. 3, 2016
(86) PCT No.: PCT/KR2016/001186

§ 371 Date: Jul. 13, 2017

(30) Foreign Application Priority Data
Feb. 3, 2015 (KR) 10-2015-0016886
Feb. 2, 2016 (KR) 10-2016-0013070

(51) Int. Cl. C08F 20/18; C09D 133/08; C09D 133/10; C08K 5/00; C08F 20/06; C08K 5/34; C08K 5/04

(52) U.S. Cl. CPC C08F 20/18; C08K 5/0025; C09D 133/08; C08F 20/06; C09D 133/10; C08K 5/04; C08K 5/34

(57) ABSTRACT

The present invention relates to a coating composition and a coating film prepared therefrom, and more particularly, to a coating composition for preparing a coating film exhibiting more improved mechanical and optical properties together with self-healing properties and impact resistance; and to a coating film prepared therefrom.

### CROSS-REFERENCE TO RELATED APPLICATION

This application claims the benefit of priority based on Korean Patent Application No. 10-2015-0016886 filed on Feb. 3, 2015 and Korean Patent Application No. 10-2016-0013070 filed on Feb. 2, 2016 with the Korean Intellectual Property Office, the disclosures of which are incorporated herein by reference in their entirety.

### TECHNICAL FIELD

The present invention relates to a coating composition and a coating film prepared therefrom, and more particularly, to a coating composition for preparing a coating film exhibiting more improved mechanical and optical properties together with self-healing properties; and to a coating film prepared therefrom.

### BACKGROUND ART

In order to protect the products from damage due to mechanical, physical and chemical influences from the outside, various coating layers or coating films are being applied to the surface of electric and electronic devices such as mobile phones or various display devices, etc., components of electronic materials, household electric appliances, automobile interior and exterior materials, or molded plastic products. However, scratches on the coated surface of the products or cracks due to external impacts deteriorate the appearance characteristic, main performance and lifespan of the products, and therefore various studies are being conducted to protect the surface of the products, thereby maintaining the quality of the products for a long period of time.

In particular, research and interest in coating materials having self-healing properties have been rapidly increasing in recent years. The self-healing property refers to a property in which, when scratches are made on the coating layer by an external physical force or stimulus applied to the coating layer, the damage such as scratches is gradually healed or reduced itself. Although various coating materials exhibiting such a self-healing property, or mechanisms of the self-healing property are known, in general, a method for using a coating material exhibiting elasticity is widely known. That is, when such a coating material is used, even if a physical damage such as scratches is applied on the coating layer, the damage site is gradually filled in because of the elasticity of the coating material itself, and thus, the self-healing property described above may be exhibited.

However, in the case of a conventional coating layer exhibiting the self-healing property, it had disadvantages in that the mechanical properties of the coating layer such as hardness, abrasion resistance or coating strength, etc. were insufficient as elastic materials were mainly included. In particular, in the case of applying a coating layer exhibiting a self-healing property to the exterior of various household electric appliances such as refrigerators or washing machines, etc., the mechanical properties of the coating layer are required on a high level, but in most cases, the coating layer having a conventional self-healing property could not satisfy such high mechanical properties. Accordingly, when a strong external stimulus was applied to the existing coating layer, there were many cases where the coating layer itself was permanently damaged, and the self-healing property was also lost.

Due to such problems of the prior arts, there has been a continuing demand for the development of a technique that enables the provision of a coating layer or film that exhibits further improved mechanical properties together with excellent self-healing properties.

### SUMMARY OF THE INVENTION

In order to solve the problems as described above, it is an object of the present invention to provide a coating composition which exhibits a self-healing property and thus is applied to the surfaces of various household electric appliances, mobile devices, display devices or the like, facilitates the handling thereof, and exhibits more improved mechanical and optical properties.

It is another object of the present invention to provide a coating film including a cured product of the above-described coating compound.

In order to achieve the above objects, the present invention provides a coating composition including: a first binder containing a hydrogen bonding functional group capable of forming multiple hydrogen bonds and a curable functional group in one molecule, a heat-curable or photo-curable second binder, a polymerization initiator and an organic solvent.

The present invention also provides a coating film including a cured product of the coating composition.

According to the present invention, there may be provided a coating composition which is applied to surfaces of various household electric appliances, mobile devices, display devices, or the like, and which enables the provision of a coating film exhibiting more improved mechanical and optical properties together with excellent self-healing properties, and a coating film formed by using the above coating composition.

By using the above coating composition, it is possible to provide a coating film having self-healing properties when scratches or cracks are generated by external impacts, and having high crack resistance, bending resistance, impact resistance and the like.

In addition, the coating film provided from the coating composition can secure high hardness and flexibility together with the self-healing properties as described above. Therefore, the film can be implemented in a bent or folded shape, and it can be usefully applied not only to a flat film but also to a mobile device, a display device, a front plate a display section of various instrument panels, and the like, including a curved portion or having a flexible shape.

### DETAILED DESCRIPTION OF THE EMBODIMENT

The coating composition of the present invention includes a first binder containing a hydrogen bonding functional group capable of forming multiple hydrogen bonds and a curable functional group in one molecule, a heat-curable or photo-curable second binder, a polymerization initiator and an organic solvent.

The coating film of the present invention also includes a cured product of the coating composition.

In the present invention, the terms first, second, etc. are used to describe various components, and the terms are used only for the purpose of distinguishing one component from another component.

In addition, the terminology used herein is for the purpose of describing exemplary embodiments only and it is intended to limit the invention. The singular expression includes plural expressions unless the context clearly indicates otherwise. As used herein, terms such as “including”, “comprising” or “having” is to define the existence of the features, stages, components, or combinations thereof, and it shall be understood as not excluding the existence and the additional possibilities of one or more other features, stages, components, or combinations thereof.

Since a variety of modifications may be made to the present invention and there are various embodiments of the present invention, examples of which will now be provided and described in detail. It should be understood, however, that the present invention is not limited to the specific disclosure forms, but includes all modifications, equivalents and alternatives falling within the spirit and scope of the present invention.

Hereinafter, the coating composition and the coating film of the present invention will be described in more detail.

According to one embodiment of the present invention, there are provided a coating composition including: a first binder containing a hydrogen bonding functional group capable of forming multiple hydrogen bonds and a curable functional group in one molecule, a heat-curable or photo-curable second binder, a polymerization initiator and an organic solvent.

As used herein, the term “curable functional group” refers to a functional group capable of being cross-linked or cured by heat and/or light (UV), and unless otherwise specified, and includes both a photo-curable functional group cured by light and a heat-curable functional group cured by heat.

In addition, crosslinking, curing, or polymerization mean that two or more of the curable functional groups are combined by various chemical reactions to form a polymer compound having a two-dimensional or three-dimensional bonding structure with a larger molecular weight. The crosslinking, curing, and polymerization are used interchangeably. Further, the cured resin means a resin formed by such crosslinking, curing, or polymerization.

Moreover, as used herein, the term “hydrogen bonding functional group” includes a hydrogen bond donor and a hydrogen bond acceptor together, and refers to a functional group capable of forming a hydrogen bond. The term “multiple hydrogen bonds” means that such a hydrogen bonding functional group forms at least two pairs of hydrogen bonds between molecules. In addition, the “hydrogen bonding functional group capable of forming multiple hydrogen bonds” means that such multiple hydrogen bonds can form a supramolecular network structure described later.

The coating composition of the present invention includes a compound containing, as a first binder, a hydrogen bonding functional group capable of forming multiple hydrogen bonds and a curable functional group in one molecule. The first binder can form two or more pairs of hydrogen bonds between molecules or within a molecule due to the hydrogen bonding functional group, and the curable functional group is cured by photo-curing and/or heat curing to form a cured resin.

In recent years, the research and interest are rapidly increasing on materials having self-healing property, that is, a property in which, when damages such as scratches or cracks occur due to external physical force or stimulus applied to the coating layer formed by the curing of the coating composition, these damages is gradually healed or reduced itself,

Although various coating materials and mechanisms exhibiting such self-healing properties are known, most commonly, a method of realizing self-healing properties by a so-called supramolecular network is widely known.

Supramolecules means macromolecules in which two or more molecule entities are held together and organized via molecular-recognition and molecular self-assembly based on intramolecular or intermolecular non-covalent bonds. The non-covalent bonds capable of forming supramolecules include hydrogen bonds, π-π interactions, van der Waals force, electrostatic attraction, metal coordination bonds, and the like. By forming a supramolecular network structure in the macromolecule via such non-covalent bonds, the network structure is re-formed by intermolecular interactions when external impact is applied, thereby allowing repetitive and reversible self-healing.

When such supramolecular network coating material is used, even if fracture of the material occurs due to an external impact on the coating layer, the bond of the separated supramolecules to the fractured surface is re-formed, the fractured surface is sealed and the damaged portion is healed, thereby exhibiting reversible and repetitive self-healing properties.

However, in order to form a supramolecular network having these self-healing properties, the mobility of the molecular chain must be secured. Molecular motility is in conflict with mechanical strength, and materials having self-healing properties are generally rubbery and have poor mechanical properties, and thus there is a limitation in applying them to coating materials.

In view of the above, according to one embodiment of the present invention, it has been found that as a first binder containing a hydrogen bonding functional group capable of forming multiple hydrogen bonds and a curable functional group in one molecule is used, not only self-healing properties can be achieved by multiple hydrogen bonds, but also the mechanical properties of high strength can be ensured. The present invention has been completed on the basis of such finding.

That is, as the coating layer is formed using the first binder, it can exhibit self-healing properties, that is, properties in which, when fracture occurred by external impact applied to the coating layer, and the hydrogen bond at the fracture surface is broken and re-formed, the damage due to such impacts is gradually healed or reduced itself. In this case, the curable functional group contained in the first binder is cross-linked with other curable functional groups to form a cross-linked polymer having a crosslinking density higher than a certain level, thereby securing both high strength and high surface hardness.

According to an embodiment of the present invention, the first binder may be represented by the following chemical formula 1.

Y-L-Z [Chemical Formula 1]

in the chemical formula 1,

Y is a moiety containing a hydrogen bonding functional group capable of forming multiple hydrogen bonds,

Z is a curable functional group, and L is a linker that links Y and Z, and is a direct bond, a linear or branched alkylene group having 1 to 10 carbon atoms, a linear or branched alkenylene having 2 to 10 carbon atoms, —NHCO—, —NR′CO—, —O—, —NH—, —NR′—, —COO—, —CONHCO—, —CONHCOR′—, —CONR′CO—, —NH—NH—, —NR′—NH—, or —NR′—NR′— (where R′ is a hydrocarbyl group having 1 to 10 carbon atoms).

Preferably, the Z is a photo-curable functional group selected from the group consisting of a (meth)acrylate group, a (meth)acryloyl group, and a vinyl group; or a heat-curable functional group selected from the group consisting of an isocyanate group, a hydroxyl group, an epoxy group, an alkoxy group, a thiol group; a melamine group, a siloxane group, and an oxetanyl group.

The hydrogen bonding functional group capable of forming multiple hydrogen bonds is not particularly limited as long as it is a functional group, a residue or a bond containing hydrogen bonded to N or O, and examples thereof may include OH group, —OR group, —NH₂ group, —NHR group, —NR₂ group, —COOH group, —COOR group, —CONH₂ group, —CONR₂ group, —NHOH group, —NROR group; or a bond present in the molecular, such as —NHCO— bond, —NRCO— bond, —O— bond, —NH— bond, —NR— bond, —COO— bond, —CONHCO— bond, —CONRCO— bond, —NH—NH— bond, —NR—NH— bond, or —NR—NR— bond. In this case, R may be an aliphatic hydrocarbon, an aromatic hydrocarbon or a derivative thereof, and examples thereof include an aliphatic hydrocarbon having 1 to 16 carbon atoms or 1 to 9 carbon atoms, an aromatic hydrocarbon having 5 to 30 carbon atoms or 5 to 16 carbon atoms, and derivatives thereof.

According to one embodiment of the present invention, the first binder can be obtained by reacting a compound containing a hydrogen bonding functional group and a compound containing a curable functional group to perform a urethane bond formation reaction, a urea bond formation reaction, an amide bond formation reaction, an ester bond formation reaction, an ether bond formation reaction, a radical polymerization reaction, a cation polymerization reaction or the like. By the above reaction, the hydrogen bonding functional group can be introduced into the branched chain or the end of the main chain, thereby obtaining a compound containing a curable functional group.

In the chemical formula 1, Y is a moiety derived from a compound containing a hydrogen bonding functional group, and the compound containing the hydrogen bonding functional group is capable of forming multiple hydrogen bonds between molecules. It is not particularly limited as long as it is a compound capable of forming a supramolecular network by multiple hydrogen bonds.

These compounds may include, for example, 2-ureido-4-pyrimidinone, 4-ureido-4-pyrimidinol, 2-uriedo-4-pyrimidone, diacylpyrimidine, 2,6-di(acetylamino)-4-pyridyl, 2,7-diamino-1,8-naphthyridine, adenine, thymine, uracil, guanine, cytosine, adenine-thymine dimer, adenine-uracil dimer, guanine-cytosine dimer, and the like.

According to another embodiment of the present invention, a compound containing a photo-curable or heat-curable functional group at the end of a compound containing a conventionally known hydrogen bonding functional group may be used as a first binder.

According to an embodiment of the present invention, the first binder may form a hydrogen bond within a first binder molecule by a hydrogen bonding functional group.

According to another embodiment of the present invention, the first binder may form a hydrogen bond between different first binder molecules by the hydrogen bonding functional group.

Alternatively, hydrogen bonds can be present both within one molecule and between different molecules.

The first binder may include a hydrogen bonding functional group capable of forming two or more pairs of hydrogen bonds, and preferably a hydrogen bonding functional group capable of forming three or more pairs of hydrogen bonds. As the first binder contains a hydrogen bonding functional group capable of forming at least two pairs of hydrogen bonds, the coating layer containing the same can exhibit self-healing properties and can facilitate the handling of the coating composition containing the same and the formation of the coating layer.

In addition, the first binder may contain about 0.01 to about 0.5 eq/mol, preferably about 0.05 to about 0.3 eq/mol equivalent of hydrogen bonding functional groups based on 1 mol of the total curable functional group contained in the second binder described later. When the equivalent of the hydrogen bonding functional group is within the above-mentioned range, the coating layer formed using the coating composition containing the hydrogen bonding functional group may exhibit glassy coating film properties while exhibiting sufficient self-healing property.

The first binder of the present invention contains a curable functional group together with the above-mentioned hydrogen bonding functional group in one molecule.

The curable functional group includes both a photo-curable functional group and a heat-curable functional group, and the first binder of the present invention may contain one or more of these in one molecule.

Examples of the photo-curable functional group may include a (meth)acrylate group, a (meth)acryloyl group, and a vinyl group, but the present invention is not limited thereto.

Examples of the heat-curable functional group may include an isocyanate group, a hydroxyl group, an epoxy group, an alkoxy group, a thiol group, a melamine group, a siloxane group, and an oxetanyl group, but the present invention is not limited thereto.

As described above, the coating composition of the present invention includes a first binder containing a hydrogen bonding functional group capable of forming multiple hydrogen bonds and a curable functional group in one molecule, thereby exhibiting more improved mechanical properties together with self-healing properties and excellent impact resistance. In other words, as the curable functional group is cured while showing a self-healing property by multiple hydrogen bonds, a hard coating layer that is not a rubber phase can be formed, and thereby a coating film having a constant strength can be formed. Further, since the first binder contains a curable functional group, handling of the coating composition and formation of a coating layer can be facilitated.

Moreover, the coating composition containing the same has high bending resistance and processability due to the multiple hydrogen bonds and the properties of the curable functional group and thus can be applied not only to a flat film but also to a film having a curved portion or a curved shape.

According to one embodiment of the present invention, the weight average molecular weight of the first binder may be about 100 to about 5,000 g/mol, or about 200 to about 3,000 g/mol, but is not limited thereto.

According to one embodiment of the present invention, the first binder can be contained in an amount of about 1 to about 50 parts by weight, or about 5 to about 30 parts by weight, based on 100 parts by weight of the total binder components (the sum of the first and second binders) contained in the coating composition. By including the first binder within the range of the above-mentioned parts by weight, it is possible to form a coating film exhibiting sufficient self-healing property and impact resistance without deteriorating mechanical properties.

The coating composition of the present invention includes a heat-curable or photo-curable second binder in addition to the first binder.

The second binder means a binder component capable of forming a cured resin by reacting with the first binder, including a photo-curable functional group and/or a heat-curable functional group.

The second binder may be cured by heat-curing and/or photo-curing to form a cured resin, or is cross-linked or cured together with a curable functional group of the first binder to form a cured resin, whereby it can serve to achieve high crosslinking density and so further improve the strength and surface strength of the coating film.

The second binder may include one of a photo-curable functional group and a heat-curable functional group, or may include both a photo-curable functional group and a heat-curable functional group.

Specific examples of the photo-curable functional group and the heat-curable functional group are the same as those described for the first binder, and the second binder may include the same or different functional groups.

The content of the second binder may be the remainder excluding the first binder among the total binder component, and the weight average molecular weight may be from about 1,000 to about 100,000 g/mol, or from about 3,000 to about 50,000 g/mol, but is not limited thereto.

To initiate the polymerization of the first and second binders described above, the coating composition of the present invention includes a polymerization initiator. The polymerization initiator may be any one or more of a photo-polymerization initiator and a heat curing agent depending on the type of the curable functional group contained in the first and second binders.

When the first or second binder contains a photo-curable functional group as a curable functional group, it includes a photo-polymerization initiator.

According to an embodiment of the present invention, the photo-polymerization initiator may be 1-hydroxy-cyclohexyl-phenyl ketone, 2-hydroxy-2-methyl-1-phenyl-1-propanone, 2-hydroxy-1-[4-(2-hydroxyethoxy)phenyl]-2-methyl-1-propanone, methylbenzoylformate, α,α-dimethoxy-α-phenylacetophenone, 2-benzoyl-2-(dimethylamino)-1-[4-(4-morpholinyl)phenyl]-1-butanone, 2-methyl-1-[4-(methylthio)phenyl]-2-(4-morpholinyl)-1-propanone diphenyl(2,4,6-trimethylbenzoyl)-phosphine oxide, bis(2,4,6-trimethylbenzoyl)-phenylphosphine oxide, or the like, but are not limited thereto. In addition, examples of products currently available in the market include Irgacure 184, Irgacure 500, Irgacure 651, Irgacure 369, Irgacure 907, Darocur 1173, Darocur MBF, Irgacure 819, Darocur TPO, Irgacure 907, Esacure KIP 100F, and the like. These photo-initiators may be used alone or in combination of two or more.

When the first or second binder contains a heat-curable functional group as a curable functional group, it may selectively include a heat curing agent as needed.

The heat curing agent can be used by selecting an appropriate compound according to the type of the heat-curable functional group. For example, when the heat-curable functional group is a hydroxyl group (—OH), a material in the form of a monomer, a dimer, a trimer, or a polymer containing an isocyanate group (—NCO) can be used as the heat curing agent. More specifically, toluene diisocyanate (TDI), hexamethylene diisocyanate (HDI), isophorone diisocyanate (IPDI) or the like can be used, but the present invention is not limited thereto.

When the first and second binders include two or more heat-curable functional groups capable of heat-curing with each other (for example, when the first and second binders each contain a hydroxyl group and an isocyanate group), it may not require a separate heat curing agent.

In addition, dibutyltin dilaurate (DBTDL) may be added as a catalyst for promoting the heat curing reaction

The polymerization initiator may be contained in an appropriate amount depending on the content of the curable functional group contained in the first and second binders.

The coating composition of the present invention includes an organic solvent for proper flowability and coatability.

As the organic solvents, any organic solvents may be used without specific limitations as long as they are known in the art to be used in coating compositions. For example, ketone-based organic solvents such as methyl isobutyl ketone, methyl ethyl ketone, dimethyl ketone, etc.; alcohol organic solvents such as isopropyl alcohol, isobutyl alcohol or normal butyl alcohol, etc.; acetate organic solvents such as ethyl acetate or normal butyl acetate, etc.; cellosolve organic solvents such as ethyl cellusolve or butyl cellusolve, etc. may be used. However, the organic solvents are not limited to the examples described above.

The content of the organic solvent is not particularly limited as it can be variously adjusted within a range not lowering the physical properties of the coating composition.

According to one embodiment of the present invention, the coating composition may further include inorganic fine particles as required. As the inorganic fine particles, inorganic fine particles having a particle diameter of nanoscale, for example, nanoparticles having a particle diameter of about 100 nm or less, or about 10 to about 100 nm, or about 10 to about 50 nm can be used. Further, as the inorganic fine particles, for example, silica fine particles, aluminum oxide particles, titanium oxide particles, zinc oxide particles, or the like can be used.

By including the inorganic fine particles, the hardness of the coating film formed including the same can be further improved.

The coating composition of the present invention having the above-described self-healing properties may further include additives commonly used in the art such as a surfactant, a yellowing inhibitor, a leveling agent, and an antifouling agent, in addition to the above-mentioned respective components. Further, the content thereof is not particularly limited as it can be variously adjusted within a range not lowering the physical properties of the composition of the present invention.

The coating composition of the present invention containing the above-mentioned components can be coated onto an object to be coated such as a molded article, a substrate, a sheet, a coating layer, or a film, and then cured to form a coating layer or a coating film.

The coating film containing the cured product obtained by curing the coating composition according to one embodiment exhibits self-healing property, impact resistance, high hardness, high strength, scratch resistance, high transparency, high transmittance, etc., and thus can be usefully used in various fields.

According to another embodiment of the present invention, there is provided a coating film comprising a cured product of the above-mentioned coating composition.

That is, the coating film is a cured product of the above-mentioned coating composition, and differs depending on the type of the curable functional group of each binder and the accompanying curing reaction, but it includes at least one cured resin selected from the group consisting of a cured resin of the first binder, a cured resin of the second binder, and a cured resin of the first and second binders. The detailed descriptions and specific exemplary compounds of the first and second binders are the same as those described above for the coating composition.

The coating film includes the cured resin of the first and second binders in this way, and the cured resin can form supramolecular network structure through multiple hydrogen bonds with high crosslink density, and thereby such structure allows to exhibit more improved mechanical and optical properties together with excellent self-healing properties.

According to one embodiment of the present invention, the coating film includes, in addition to the cured resin in which the first binder is cured and the cured resin in which the second binder is cured, a cured resin in which the first and second binders are cured together.

The coating film may be formed by coating the above-described coating composition onto at least one surface of a substrate, and then curing it through a photo-curing and/or heat curing step. That is, depending on the type of the curable functional group contained in the first and second binders of the above-mentioned coating composition, a coating film can be formed by photo-curing, heat curing, or double curing of the photo-curing and the heat curing.

In addition, the coating composition may be coated onto one surface or both surfaces of the substrate as needed. At this time, as the substrate, various substrates known in the art to which the present invention belongs may be used depending on the use of the coating film. Further, the coating film of the present invention may be provided including a substrate, or it may be applied in the form of an independent film after the substrate is peeled off after completion of the curing of the coating composition.

More specifically, according to an embodiment of the present invention, the substrate may be a film including, for example, polyester such as polyethyleneterephtalate (PET), polyethylene such as ethylene vinyl acetate (EVA), cyclic olefin polymer (COP), cyclic olefin copolymer (COO), polyacrylate (PAC), polycarbonate (PC), polyethylene (PE), polymethyl methacrylate (PMMA), polyetheretherketone (PEEK), polyethylenenaphthalate (PEN), polyetherimide (PEI), polyimide (PI), triacetylcellulose (TAC), methyl methacrylate (MMA), fluorine-based resin, or the like. The substrate may be a single layer or, if necessary, a multilayer structure including two or more substrates made of the same or different materials, and is not particularly limited.

The coating composition may be coated onto a substrate by a variety of methods known in the art. As a non-limiting example, the coating composition may be coated by a bar coating method, a knife coating method, a roll coating method, a blade coating method, a die coating method, a micro gravure coating method, a comma coating method, a slot die coating method, a lip coating method, a solution casting method, or the like.

According to one embodiment of the present invention, the coating composition described above can be coated so as to have a minimum thickness of about 5 μm, or about 10 μm, or about 20 μm and a maximum thickness of 200 μm, or about 150 μmm, or about 100 μm after it is cured completely, but the thickness of the coating film is not limited to the above-mentioned range.

According to one embodiment of the present invention, the coating film may be formed on only one surface of the substrate.

According to another embodiment of the present invention, the coating film may be formed on both surfaces of the substrate.

As a light source usable in the light irradiation step for photo-curing, various light sources known in the technical field to which the present invention belongs can be used. As a non-limiting example, a high-pressure mercury lamp, a metal halide lamp, a black light fluorescent lamp, or the like can be used.

Moreover, the heat curing can be carried out by heating at a temperature of about 60 to about 150° C., or about 90 to about 130° C. for about 1 minute to about 50 minutes, or about 1 minute to about 30 minutes. However, it is not limited to the above temperature range, and it can be appropriately adjusted depending on the type and thickness of the substrate, the thickness of the coating e.

According to an embodiment of the present invention, at least one of the layer, membrane or film such as a plastic resin film, an adhesive film, a release film, a conductive film, a conductive layer, a coating layer, a cured resin layer, a nonconductive film, a metal mesh layer or a patterned metal layer can be further included on the coating film. Further, the layer, film, membrane, film or the like may be in any form of a single layer, a double layer, or a laminated type. The layer, film, membrane, film or the like can be formed by laminating a freestanding film using an adhesive, an adhesive film or the like or laminating on the coating film by coating, vapor deposition, sputtering, or the like, but the present invention is not limited thereto.

The coating film of the present invention exhibits excellent self-healing properties, impact resistance, high hardness, scratch resistance, high transparency, high light transmittance and the like, and thus can be usefully used in various fields. In other words, it exhibits excellent self-healing properties in which even when damage such as scratches and cracks is generated by external impact, the damage is healed itself, and also exhibits excellent mechanical properties, and thus can play a role of properly protecting the exterior of the various household electric appliances, display elements or molded articles.

For example, the coating film of the present invention has a self-healing property in which, when the film is bent under conditions of room temperature (about 25° C.) or warming temperature (about 60° C.) and stretched in a flat state, a crack occurring near a folded line disappears within 10 minutes.

Further, the coating film of the present invention may have an elastic modulus of 500 MPa or more, or 700 MPa or more, or 1000 MPa or more, as measured by a tensile test. Furthermore, the upper limit of the elastic modulus may be 2000 MPa, or 1500 MPa, or 1300 MPa.

Further, the coating film of the present invention may have a light transmittance of 90% or more, or 91% or more, and a haze of 1.5% or less, or 1.0% or less.

In addition, the coating film of the present invention may exhibit a haze of 1% or less or 0.5% or less. The lower limit of the haze is not particularly limited, and may be, for example, 0%.

The coating film of the present invention can be used in various fields. For example, it is used by adhering to the appearance of various household electric appliances, or for application as a cover substrate or an element substrate of a mobile communication terminal, a smartphone or a tablet PC touch panel, and various displays.

Hereinafter, the operation and effect of the present invention will be described in more detail through specific examples. However, these Examples are given for illustrative purposes only, and the scope of the invention is not intended to be limited by these Examples.

### EXAMPLES

### Production Example of First Binder

### Preparation Example 1

10 g of 2-amino-4-hydroxy-6-methylpyrimidine and 100 g of isophorone diisocyanate were mixed and stirred at a temperature of 90° C. for 72 hours.

The reaction mixture was precipitated with hexane to obtain a first binder compound of the following structural formula having an introduced isocyanate group and containing multiple hydrogen bonding functional groups (Mw=347.42 g/mol).

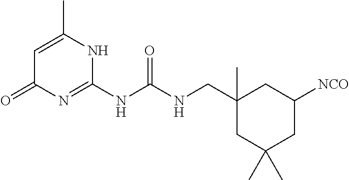

### Preparation Example 2

10 g of the compound of Preparation Example 1, 4.2 g of hydroxybutyl acrylate and 0.01 g of dibutyltin dilaurate (DBTDL) were dissolved in 15 g of methyl ethyl ketone (MEK) and stirred at a temperature of 90° C. for 24 hours. The reaction mixture was precipitated with hexane to obtain a first binder compound of the following structural formula having an introduced acrylate group and containing multiple hydrogen bonding functional (Mw=463.54 g/mol).

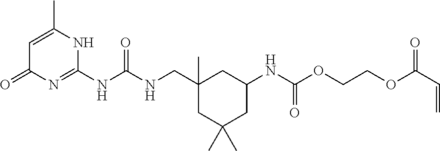 [SMILES: C=CC(=O)OCCOC(=O)NC1CC(C)(C)CC(C)(CNC(=O)Nc2nc(=O)cc(C)[nH]2)C1]

### Preparation Example of Coating Film

### Example 1

13 g of the compound of Preparation Example 1 as a first binder, 87 g of the polyol compound 7331-1-xs-70 (hydroxyl equivalent=567 g/eq, Eternal) as a second binder, 100 g of methyl ethyl ketone (MEK) and 0.0001 g of dibutyl tin laurate (DBTDL) were mixed to prepare a coating composition.

The coating composition was coated onto one surface of a PET substrate having a thickness of 125 μm and thermally cured at a temperature of 90° C. for 30 minutes to obtain a coating film having a thickness of 20 μm and thermally cured at a temperature of 90° C. for 30 minutes to obtain a coating film having a thickness of 20 μm.

### Example 2

12 g of the compound of Preparation Example 1 as a first binder, 87 g of the polyol compound 7331-1-xs-70 (Eternal) and 5 g of a polyfunctional isocyanate compound E405-80T (isocyanate group equivalent=606 g/eq, Asahi Kasei) as a second binder, 100 g of methyl ethyl ketone (MEK) and 0.0001 g of dibutyl tin dilaurate (DBTDL) were mixed to prepare a coating composition.

The coating composition was coated onto one surface of a PET substrate having a thickness of 125 μm and thermally cured at a temperature of 90° C. for 30 minutes to obtain a coating film having a thickness of 20 μm and thermally cured at a temperature of 90° C. for 30 minutes to obtain a coating film having a thickness of 20, μm.

### Example 3

10 g of the compound of Preparation Example 1 as a first binder, 45 g of the polyol compound 7331-1-xs-70 (Eternal) and 50 g of trimethylolpropane triacrylate (TMPTA, Mw=296.31 g/mol) as a second binder, 100 g of methyl ethyl ketone (MEK), 0.0001 g of dibutyl tin dilaurate (DBTDL) and 0.5 g of photo-polymerization initiator (trade name: Irgacure 184) were mixed to prepare a coating composition.

The coating composition was coated onto one surface of a PET substrate having a thickness of 125 μm, thermally cured at a temperature of 90° C. for 30 minutes, and then photo-cured with a metal halide lamp at a light quantity of 200 mj/cm² to obtain a coating film having a thickness of 20 μm.

### Example 4

10 g of the compound of Preparation Example 1 as a first binder, 90 g of a double curing binder (trade name: SMP-220A, hydroxyl group equivalent=220 g/eq, acrylate group equivalent 220 g/eq) containing a hydroxyl group and an acrylate group as a second binder, 100 g of methyl ethyl ketone (MEK), 0.0001 g of dibutyl tin dilaurate (DBTDL) and 1 g of photo-polymerization initiator (trade name: Irgacure 184) were mixed to prepare a coating composition.

The coating composition was coated onto one surface of a PET substrate having a thickness of 125 μm, thermally cured at a temperature of 90° C. for 30 minutes, and then photo-cured with a metal halide lamp at a light quantity of 200 mj/cm² to obtain a coating film having a thickness of 20 μm.

### Example 5

10 g of the compound of Preparation Example 2 as a first binder, 90 g of SMP-220A 90 g as a second binder, 100 g of methyl ethyl ketone (MEK), 0.0001 g of dibutyl tin dilaurate (DBTDL) and 1 g of photo-polymerization initiator (trade name: Irgacure 184) were mixed to prepare a coating composition.

The coating composition was coated onto one surface of a PET substrate having a thickness of 125 μm, thermally cured at a temperature of 90° C. for 30 minutes, and then photo-cured with a metal halide lamp at a light quantity of 200 mj/cm² to obtain a coating film having a thickness of 20 μm.

### Comparative Example 1

93 g of polyol compound 7331-1-xs-70 (Eternal), 7 g of toluene diisocyanate, 100 g of methyl ethyl ketone (MEK) and 0.0001 g of dibutyl tin dilaurate (DBTDL) were mixed to prepare a coating composition.

The coating composition was coated onto one surface of a PET substrate having a thickness of 125 μm, and then thermally cured at a temperature of 90° C. for 30 minutes to obtain a coating film having a thickness of 20 μm.

### Comparative Example 2

100 g of SMP-220A, 100 g of methyl ethyl ketone (MEK), 0.0001 g of dibutyl tin dilaurate (DBTDL) and 1 g of photo-polymerization initiator (trade name: Irgacure 184) were mixed to prepare a coating composition.

The coating composition was coated onto one surface of a PET substrate having a thickness of 125 μm, thermally cured at a temperature of 90° C. for 30 minutes, and then photo-cured with a metal halide lamp at a light quantity of 200 mj/cm² to obtain a coating film having a thickness of 20 μm.

### Experimental Example

The physical properties of the coating films of Examples 1 to 5 and Comparative Examples 1 and 2 were measured by the following methods, and the results are shown in Table 1 below.

1) Self-Healing Property

Each coating film was bent with a curvature of 10 Θ with a coating layer as an outside surface, kept for 10 seconds, stretched to 180°, flattened again, and observed with an optical microscope to see whether cracks of the folded line disappeared within 10 minutes.

The temperature at which the cracks disappear was checked under the temperature conditions at 25° C. and 60° C., respectively. When the crack does not disappear even at 25° C., it is indicated by X.

2) Transmittance and Haze

Transmittance and haze were measured using a spectrophotometer (instrument name: COH-400).

3) Elastic Modulus

The same coating compositions as in Examples 1 to 5 and Comparative Examples 1 and 2 were used, but they were coated and cured on the release film substrate so that the thickness of the coating film was 70 μm, followed by peeling-off only the coating layer to obtain a coating film.

The elastic modulus was measured on a coated film piece (width of 1 cm, length of 10 cm) in a substrate-less state using a Texture Analyzer (TA. XTPlus, Texture technologies) through a tensile strength test.

4) Pencil Hardness:

After reciprocating once on the coating surface of each coating film with a load of 500 g according to the measurement standard JIS K 5400, the hardness without scratches was confirmed.

The pencil hardness of the coating layer was measured according to JIS K5400 with a load of 500 g.

TABLE 1

| | | | | | | Comparative | Comparative |
|---|---|---|---|---|---|---|---|
| | Example | Example | Example | Example | Example | Example | Example |
| | 1 | 2 | 3 | 4 | 5 | 1 | 2 |
| Self-healing | 60° C. | 25° C. | 25° C. | 25° C. | 60° C. | X | X |
| property | | | | | | | |
| temperature | | | | | | | |
| Transmittance | 91.0% | 91.2% | 91.2% | 91.3% | 91.0% | 91.1% | 91.2% |
| Haze | 0.7% | 0.8% | 0.7% | 0.6% | 0.5% | 0.7% | 0.6% |
| Elasticmodulus | 780 MPa | 550 MPa | 970 MPa | 1120 MPa | 1210 MPa | 320 MPa | 1030 MPa |
| Pencil | 2B | 4B | H | 2H | 2H | 4B | 2H |
| hardness | | | | | | | |

With reference to Table 1, it was confirmed that the coating films of Examples 1 to 5 exhibited excellent self-healing properties, high transparency, and high strength, whereas the coating films of Comparative Examples 1 and 2 did not exhibit self-healing properties.

What is claimed is:

1. A coating composition including:
a first binder containing a hydrogen bonding functional group capable of forming multiple hydrogen bonds and a curable functional group in one molecule, a heat-curable or photo-curable second binder, a polymerization initiator and an organic solvent.

2. The coating composition according to claim 1, wherein the hydrogen bonding functional group includes at least functional group selected from the group consisting of OH group, —OR group, —NH₂ group, —NHR group, —NR₂ group, —COOH group, —COOR group, —CONH₂ group, —CONR₂ group, —NHOH group, and —NROR group; or at least one bond selected from the group consisting of —NHCO— bond, —NRCO— bond, —O— bond, —NH— bond, —NR— bond, —COO— bond, —CONHCO— bond, —CONRCO— bond, —NH—NH— bond, —NR—NH— bond, and —NR—NR— bond.

3. The coating composition according to claim 1, wherein the first binder is contained in an amount of 1 to 50 parts by weight based on 100 parts by weight of the sum of the first and second binders.

4. The coating composition according to claim 1, wherein the curable functional group includes at least one photo-curable functional group selected from the group consisting of a (meth)acrylate group, a (meth)acryloyl group, and a vinyl group; or at least one heat-curable functional group selected from the group consisting of an isocyanate group, a hydroxyl group, an epoxy group, an alkoxy group, a thiol group, a melamine group, a siloxane group, and an oxetanyl group.

5. The coating composition according to claim 1, wherein the first binder is a binder in which the hydrogen bonding functional group is introduced into the branched chain or the end of the main chain.

6. The coating composition according to claim 1, wherein the first binder is represented by the following chemical formula 1.
Y-L-Z [Chemical Formula 1]
in the chemical formula 1,
Y is a moiety containing a hydrogen bonding functional group capable of forming multiple hydrogen bonds,
Z is a curable functional group, and
L is a linker that links Y and Z, and is a direct bond, a linear or branched alkylene group having 1 to 10 carbon atoms, a linear or branched alkenylene having 2 to 10 carbon atoms, —NHCO—, —NR′CO—, —O—, —NH—, —NR′—, —COO—, —CONHCO—, —CONHCOR′—, —CONR′CO—, —NH—NH—, —NR′—NH—, or —NR′—NR′— (where R′ is a hydrocarbyl group having 1 to 10 carbon atoms).

7. The coating composition according to claim 6, wherein the Y is derived from any one or more compounds selected from the group consisting of 2-ureido-4-pyrimidinone, 4-ureido-4-pyrimidinol, 2-uriedo-4-pyrimidone, diacylpyrimidine, 2,6-di(acetylamino)-4-pyridyl, 2,7-diamino-1,8-naphthyridine, adenine, thymine, uracil, guanine, cytosine, adenine-thymine dimer, adenine-uracil dimer, and guanine-cytosine dimer.

8. The coating composition according to claim 6, wherein the first binder contains 0.01 to 0.5 eq/mol of hydrogen bonding functional groups based on 1 mol of the total curable functional group contained in the second binder.

9. A coating film comprising a cured product of the coating composition according to claim 1.

10. The coating film according to claim 9, wherein the cured product includes at least one selected from the group consisting of a cured resin of the first binder, a cured resin of the second binder, and a cured resin of the first and second binders.

11. The coating film according to claim 10, wherein the curable functional group includes at least one photo-curable functional group selected from the group consisting of a (meth)acrylate group, a (meth)acryloyl group, and a vinyl group; or at least one heat-curable functional group selected from the group consisting of an isocyanate group, a hydroxyl group, an epoxy group, an alkoxy group, a thiol group, a melamine group, a siloxane group, and an oxetanyl group.

12. The coating film according to claim 9, wherein the cured product forms supramolecular network structure through multiple hydrogen bonds.

13. The coating film according to claim 9, having self-healing properties.

14. The coating film according to claim 9, wherein the elastic modulus of the film having a thickness of 70 μm measured by a tensile strength test method is 500 MPa or more.

15. The coating film according to claim 9, wherein the coating film has a light transmittance of 90% or more and a haze of 1.5% or less.
